(19) United States
(12) Patent Application Publication
(10) Pub. No.: US 2025/0346439 A1
(43) Pub. Date: Nov. 13, 2025

(54) ALTERNATIVE INVERTING CONTAINER HANDLING SYSTEM AND METHOD

(71) Applicant: Morrison Timing Screw Company dba Morrison Container Handling Solutions, Glenwood, IL (US)

(72) Inventors: Cody Halminiak, Willowbrook, IL (US); Michael Norman, Munster, IN (US); Nick Wilson, Palm Coast, FL (US); Alan Coyle, Crown Point, IN (US); Ryan Finke, Chicago, IL (US)

(73) Assignee: Morrison Timing Screw Company dba Morrison Container Handling Solutions, Glenwood, IL (US)

(21) Appl. No.: 19/202,518

(22) Filed: May 8, 2025

Related U.S. Application Data
(60) Provisional application No. 63/645,097, filed on May 9, 2024.

(51) Int. Cl. B65G 47/248; B65G 33/04; B65G 47/32

(52) U.S. Cl. CPC B65G 47/248; B65G 33/04; B65G 47/32

(57) ABSTRACT

A system for receiving objects to a conveying screw in an infeed sequence in an upward orientation, twisting the objects from the upward orientation to a sideways orientation by progressing the objects between a twisting plate and the conveying screw, conveying the objects in the sideways orientation in sets, each set including a first and second object to a diverting screw, inverting the first object to a downward orientation by diverting the first object between an inverting plate and the conveying screw, reverting the second object to the upward orientation by diverting the second object between a reverting plate and the conveying screw, discharging the objects from the conveying screw in sets in a discharge sequence in which each downward object is alternated with and adjacent an upward object. The object can have a tapered side where in the discharge sequence, tapered sides of adjacent containers are substantially parallel.

### CROSS-REFERENCE TO RELATED APPLICATIONS

The present application claims the benefit of priority to U.S. Provisional Patent Application No. 63/645,097 filed on May 9, 2024, which is hereby incorporated by reference in its entirety.

### TECHNICAL FIELD

The present disclosure relates to a drive system for receiving objects in an upward orientation, inverting alternate objects in the sequence from the upward orientation to a downward orientation, and discharging the objects in a discharge sequence in which each upward object is alternated with and adjacent a downward object, in an alternate inverted pattern.

### BACKGROUND

The packing density of tapered objects, such as containers, can be optimized by alternating the tapered objects in upward and downward orientations, in an alternate inverted pattern, such that the tapered surfaces of the adjacent objects are substantially parallel to each other, e.g., the top end of each upward object abuts or touches the bottom edge of an adjacent object, to minimize empty space between the containers. Pick and place mechanisms can be used to place the tapered objects in the alternate inverted pattern, however these mechanisms may be disadvantaged by slower cycle times and/or by intermittently dropping containers. A conveyor system can be used to alternatively infeed containers in an upward orientation from a first conveyor and containers in a downward orientation from a second conveyor to outfeed containers in upward orientation alternated with and adjacent to downward containers, however this system requires a continuous inflow of containers from each of the first and second conveyors to avoid misfeeds and/or mis-sequencing of containers.

### SUMMARY

A system and method for receiving objects to a conveying screw in an infeed sequence in an upward orientation, twisting the objects from the upward orientation to a sideways orientation by progressing the objects between a twisting plate and the conveying screw, conveying the objects in the sideways orientation in sets, each set including a first and second object, to a diverting screw, inverting the first object to a downward orientation by diverting the first object between an inverting plate and the conveying screw, reverting the second object to the upward orientation by diverting the second object between a reverting plate and the conveying screw, discharging the objects from the conveying screw in sets in a discharge sequence in which each downward object is alternated with and adjacent a upward object, in an alternate inverted pattern, are provided. The object can have a tapered side where in the discharge sequence, tapered sides of adjacent containers are immediately adjacent each other and/or substantially parallel to each other.

The system and method for alternate inverting of objects, as described herein and in an illustrative example, comprises receiving objects via an infeed conveyor portion of a conveyor to an infeed portion of a conveying screw and a support rail portion of a diverting screw, the objects in a sideways orientation relative to the infeed conveyor portion; conveying the objects in the sideways orientation along the conveying screw, from the support rail portion to a diverting screw thread of the diverting screw; conveying the objects via the diverting screw thread in sets along the conveying screw, each set including a first object and a second object; diverting, via the diverting screw, the first object of each set to an inverting plate adjacent the conveying screw; inverting the first object of each set between the inverting plate and the conveying screw to a downward orientation relative to the infeed conveyor portion; diverting, via the diverting screw, the second object of each set to a reverting plate adjacent the conveying screw; reverting the second object of each set between the reverting plate and the conveying screw to an upward orientation relative to the infeed conveyor portion; and discharging to a discharge conveyor portion, via a discharge portion of the conveying screw, the first and second objects in a discharge sequence in which each object in the downward orientation is alternated with an object in the upward orientation.

In an illustrative example, the conveying screw is positioned between the inverting plate and the reverting plate. In one example, the system includes an inverting contoured surface defined by the inverting plate; and an inverting pocket defined by the inverting contoured surface and the conveying screw; the method including receiving the first object from the diverting screw to the inverting pocket. In an illustrative example, the system includes a reverting contoured surface defined by the reverting plate; and a reverting pocket defined by the reverting contoured surface and the conveying screw; the method including receiving the second object from the diverting screw to the reverting pocket. In an illustrative example, the system and method includes maintaining the object in continuous contact with the support rail portion of the diverting screw when the object is in the sideways orientation.

In an illustrative example, the object defines a center of gravity; the system including a diverting screw axis defined by the diverting screw; a first plane including the diverting screw axis; a conveying screw axis defined by the conveying screw; a second plane including the conveying screw axis; where the first and second planes are intersecting and perpendicular to each other such that the center of gravity is offset from the first plane with the object in the sideways orientation.

In an illustrative example, the system and method can include receiving the objects between the infeed conveyor portion and a twisting plate; where the twisting plate is adjacent the infeed portion of the conveying screw; the method including conveying, via the infeed conveyor portion, the objects in an initial upward orientation to the infeed portion of the conveying screw; and twisting the objects from the initial upward orientation to the sideways orientation by conveying the objects between the twisting plate and the conveying screw. In an illustrative example, the system and method can include a twisting contoured surface defined by the twisting plate; a twisting pocket defined by the twisting contoured surface and the conveying screw; and the twisting pocket configured to receive the object from the infeed conveyor portion. In an illustrative example, the object has a frustoconical shape defining a tapered side; and in the discharge sequence, a tapered side of the first object in the downward orientation is parallel to a tapered side of the second object in the upward orientation.

The system and method described herein for inverting alternate containers in a sequence is characterized by numerous advantages as compared with pick and place methods and systems for alternating the orientation of containers in a sequence. For example, by maintaining a continuous supportive contact of the container throughout the infeed, twisting, reverting and/or inverting, and alternating processes, instability of the container during movement is minimized and/or substantially eliminated. Further, the alternating upward and downward containers exhibit greater stability for transfer via conveyor, for example, relative to a sequence of containers which are all in an upward orientation, where point to point contact at the top edges of the adjacent containers has a greater potential for tipping relative to alternating upward and downward containers having tapered sides of adjacent containers which are substantially parallel to each other. By comparison, alternating upward and downward containers are readily transported via conveyors, chutes, etc. to subsequent operations such as sleeving, bulk packing, etc., where the alternate inverted pattern of the alternating upward and downward containers increase the pack density of the containers as compared to containers which are all oriented in a single upward or single downward direction. The continuous flow aspect of the process disclosed herein, where contact with the containers by the conveying screw through infeed, translation of the containers by the conveying screw in conjunction with the twisting plate from upward to sideways orientation, conveying the containers in sets of two to a diverting screw such that the first container of each set is inverted by the diverting screw and an inverting plate to a downward orientation and the second container of each set is reverted by the diverting screw and a reverting plate to be conveyed by a discharge end of the conveying screw to a discharge chute in as a set including the first container in an downward orientation and the second set in an upward orientation, combining the first and second containers in alternating orientation to adjacent containers for discharge in a single lane, enables high speed movement of the containers through the twisting, diverting, inverting, reverting and discharge segments, such that relatively high throughputs in the range of up to 1450 containers per minute (cpm) have been realized. Further, because of the continuous flow aspect of the process, the throughput rate can be varied by modifying the rotation speed of the conveying and diverting screws, such that the throughput of the line can be continuously varied in a range of 0 cpm to about 1450 cpm.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a perspective view of a drive system for receiving objects in an upward orientation, inverting alternate objects in the sequence to a downward orientation, and discharging the objects in a sequence in which each upward object is alternated with and adjacent a downward object, the drive system including a conveying screw, a diverting screw, a twisting plate, an inverting plate and a reverting plate;

FIG. 1A is an end view of the drive system of FIG. 1, showing the direction of rotation of a conveying screw and the diverting screw;

FIG. 2 is a schematic illustration of an infeed sequence of objects as received into the drive system of FIG. 1, each of the objects in an upward orientation in the infeed sequence;

FIG. 3 is a schematic illustration of a discharge sequence of objects as discharged from the drive system of FIG. 1, in which each upward object is alternated with and adjacent a downward object in the discharge sequence;

FIG. 4 is a schematic illustration of a top view of the drive system of FIG. 1 showing the placement of the conveying screw relative to the twisting plate, diverting screw, the inverting plate and the reverting plate;

FIG. 5 is a schematic illustration of a backside view of the drive system of FIG. 1 showing the placement of the conveying screw relative to the diverting screw, the inverting plate and the reverting plate;

FIG. 6 is a schematic illustration of a frontside view of the drive system of FIG. 1 showing the placement of the conveying screw relative to the twisting plate, the diverting screw, the inverting plate and the reverting plate;

FIG. 7 is a schematic illustration of a top view of the drive system of FIG. 1 showing the placement of the conveying screw relative to the twisting plate, diverting screw, the inverting plate and the reverting plate, further showing an infeed sequence of objects as received into the drive system of FIG. 1, each of the objects in an upward orientation in the infeed sequence as shown in FIG. 2, and a discharge sequence of objects as discharged from the drive system of FIG. 1, in which each upward object is alternated with and adjacent a downward object in the discharge sequence as shown in FIG. 3, FIG. 7 further showing the twisting plate, inverting plate and reverting plate in exploded view;

FIGS. 8 and 9 are schematic illustrations of a top view of the drive system of FIG. 1, showing objects conveyed through the drive system in sets, each set S including a first object A and a second object B, receiving the objects in the infeed sequence showing in FIG. 2, twisting the objects from the upward orientation to a sideways orientation by progressing the objects between the twisting plate and the conveying screw, conveying the objects in the sideways orientation in sets S to the diverting screw, inverting the first object A in each set S to a downward orientation by diverting each first object A between the inverting plate and the conveying screw, reverting the second object B in each set S to the upward orientation by diverting each second object B between the reverting plate and the conveying screw, discharging the objects from the conveying screw through a discharge chute in the discharge sequence shown in FIG. 3, in which each downward oriented object A is alternated with and adjacent an upward oriented object B;

FIG. 10 is a schematic illustration of FIG. 8 showing an alternate inverting method for conveying objects through the drive system of FIG. 1, including receiving the objects in the infeed sequence shown in FIG. 2 and discharging the objects in a single lane in the discharge sequence shown in FIG. 3;

FIGS. 11, 12 and 13 are a series of schematic images of the drive system of FIG. 1, illustrating the progression of three sets of objects through the diverting, reverting and inverting segments of the method illustrated in FIG. 10; and

FIG. 14 is a schematic illustration of cross-section B-B of FIG. 10 showing the position of the object in the sideways orientation, relative to the conveying screw and the infeed portion of the diverting screw.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

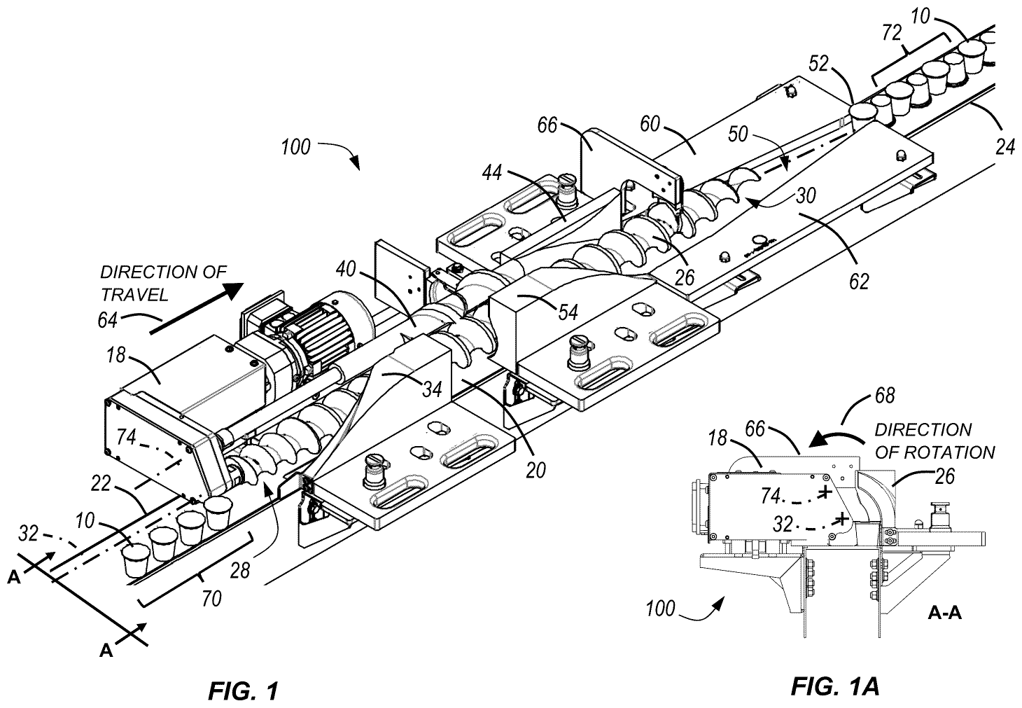

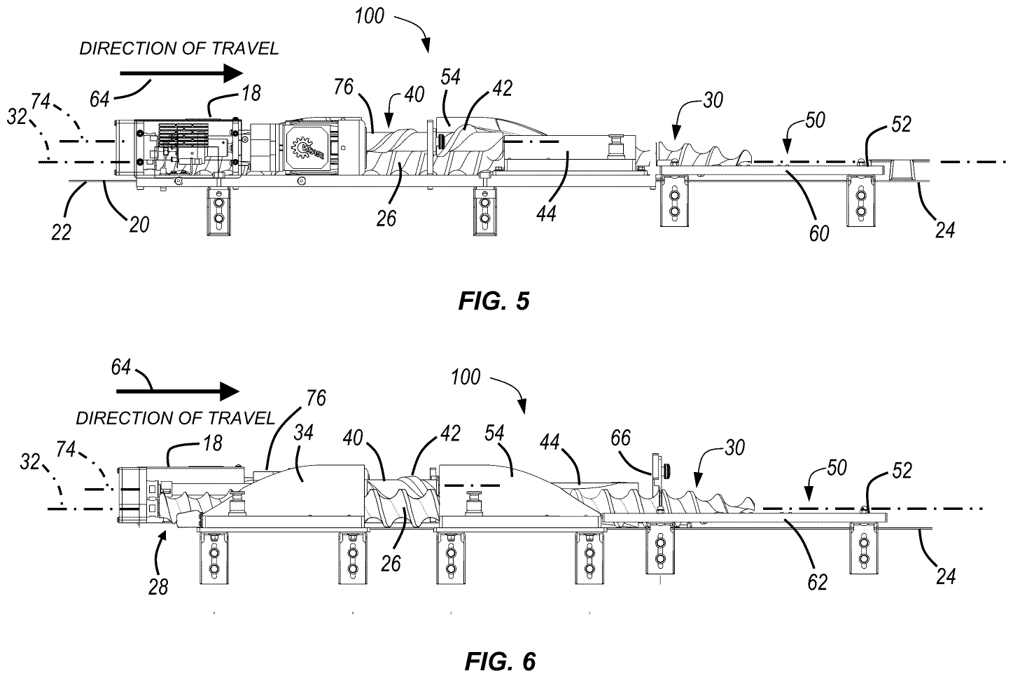

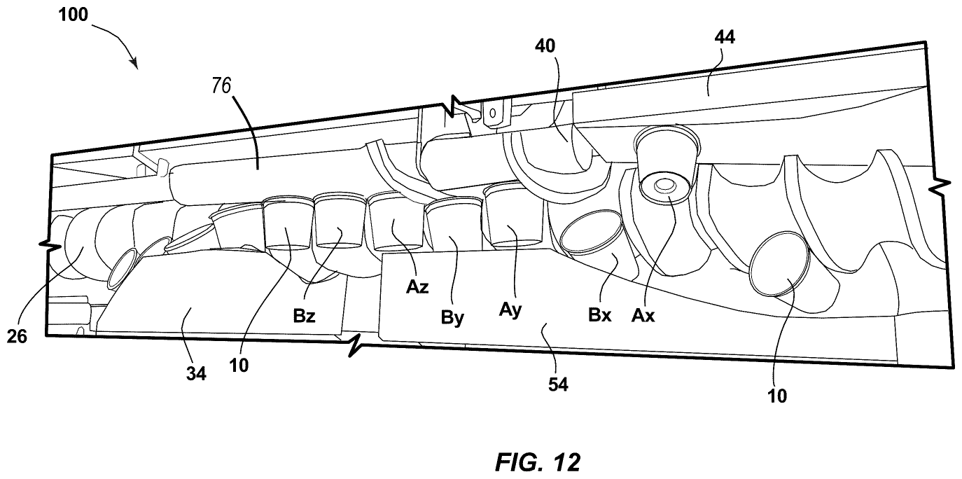

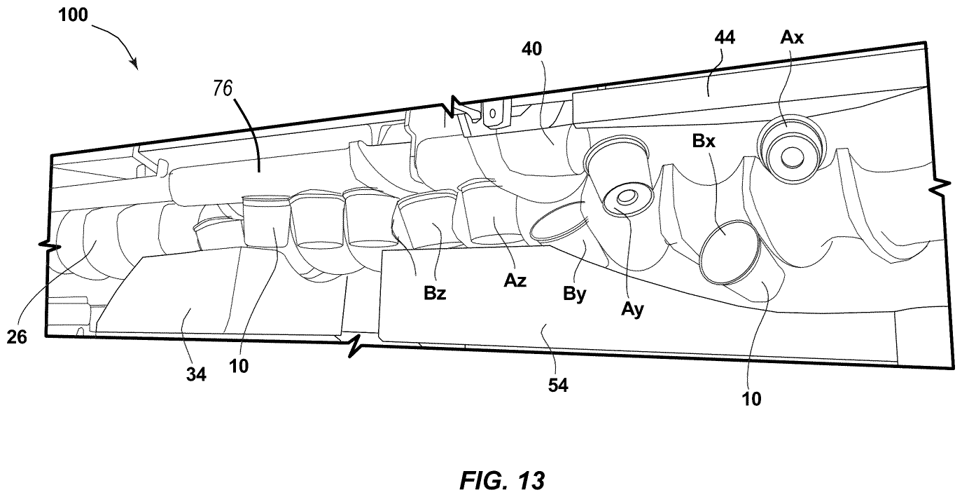

Referring to the drawings wherein like reference numbers represent like components throughout the several figures, the elements shown in FIGS. 1-14 are not necessarily to scale or proportion. Accordingly, the particular dimensions and applications provided in the drawings presented herein are not to be considered limiting. FIGS. 1 and 1A can be collectively referred to herein as FIG. 1.

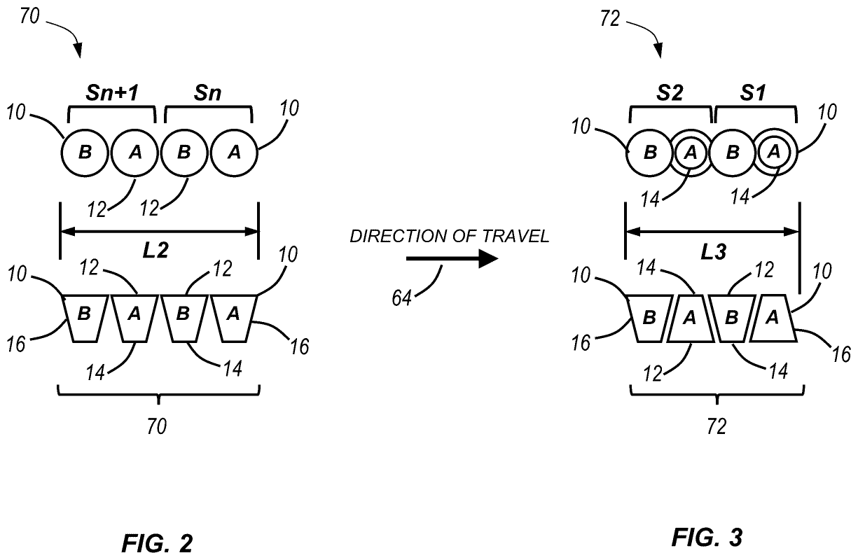

Referring to FIGS. 1-14, an alternate inverting drive system 100 and an alternate inverting method 200 for receiving objects 10 in an infeed sequence 70 in an initial upward orientation as shown in FIG. 2, inverting alternate objects 10 in the sequence to a downward orientation, and discharging the objects 10 in a discharge sequence 72 in which each upward object 10 is alternated with and adjacent a downward object 10 in the discharge sequence 72 as shown in FIG. 3, are provided. An upward object 10 can be described herein as an upward oriented object 10. A downward object 10 can be described herein as a downward oriented object 10.

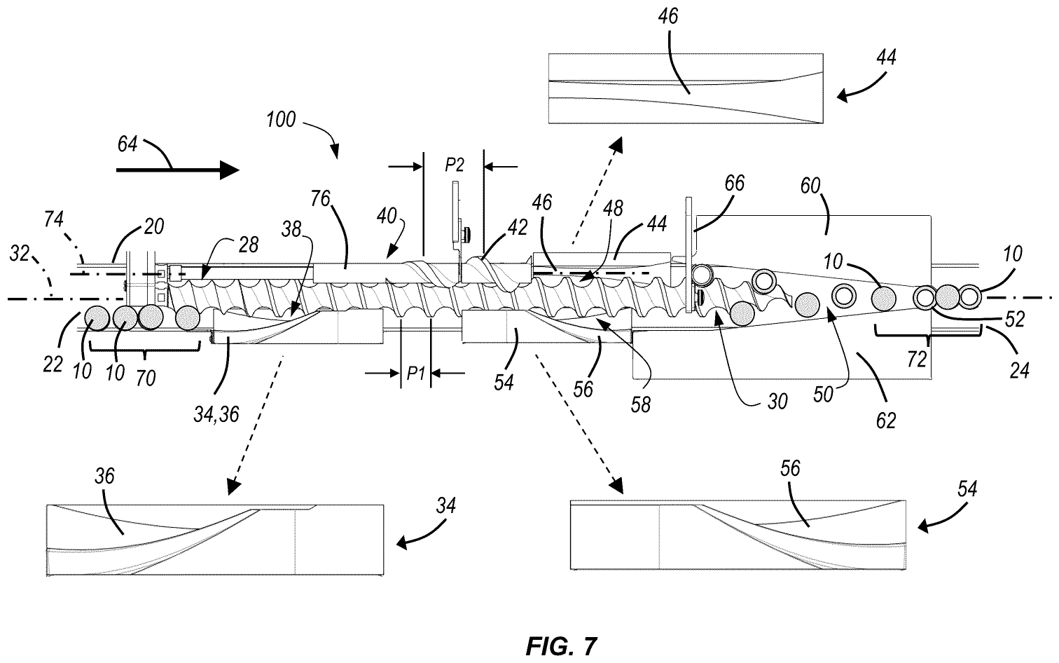

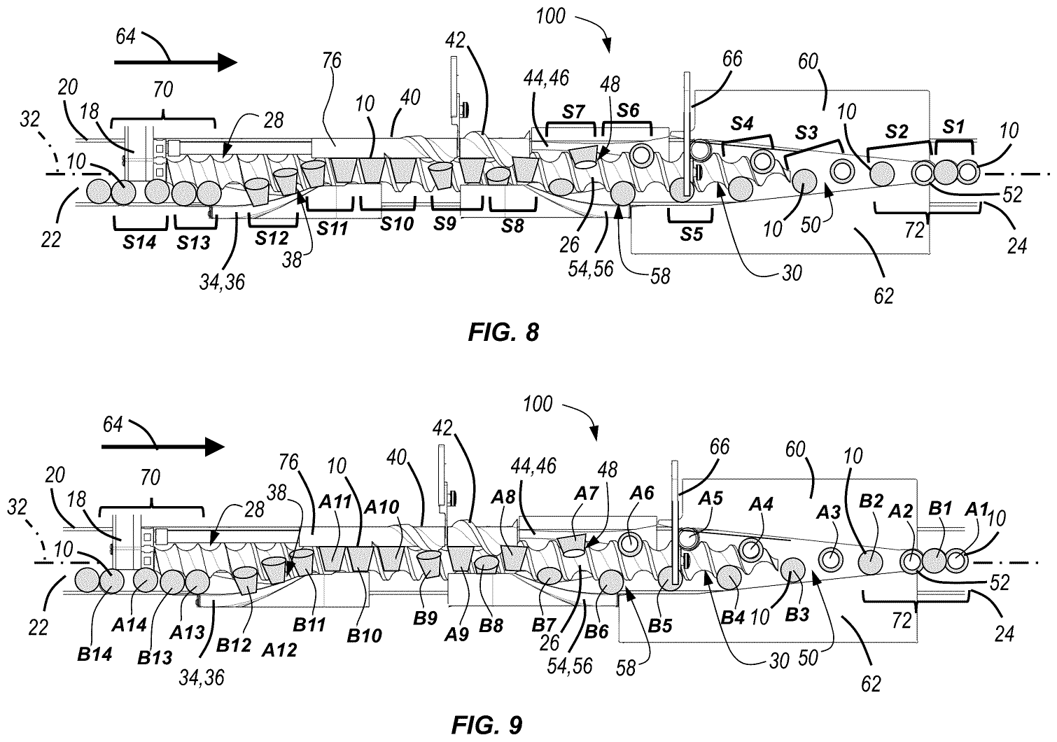

As shown in FIGS. 1-14 and as described by the alternate inverting method 200, the alternate inverting drive system 100, also referred to herein as the drive system 100, receives objects 10 in an initial upward orientation via a conveyor 20 to a conveying screw 26 in the infeed sequence 70 shown in FIGS. 1 and 2. The upward orientation, sideways orientation, and downward orientation of the object 10, in the illustrative example shown, are relative to the conveyor 20. As the objects 10 are progressed along an infeed conveyor portion 22, an infeed portion 28 of the conveying screw 26 sequentially conveys each object 10 via twisting pockets 38 formed between a twisting plate 34 and the conveying screw 26, such that the object 10 is twisted by a twisting contoured surface 36 of the twisting plate 34 and the rotation of the conveying screw 26 from the initial upward orientation to a sideways orientation as shown in FIGS. 8-14. The objects 10 in the sideways orientation are conveyed by the conveying screw 26 along an infeed portion 76 of a diverting screw 40, as shown in FIGS. 8-14, and received in sets S of two objects 10 into a diverting screw thread 42 of the diverting screw 40, each set S including a first object A and a second object B. The infeed portion 76 of the diverting screw 40 can also be referred to herein as a support rail portion 76, for supporting the objects 10 in the sideways orientation as the objects 10 are progressed axially by the conveying screw 26. As the set S is conveyed by rotation of the conveying screw 26 and the diverting screw 40, the first object A exits the diverting screw 40 and is rotated by the conveying screw 26 into an inverting pocket 48 (see FIG. 7) formed between an inverting plate 44 and the conveying screw 26, such that the first object A is inverted by an inverting contoured surface 46 of the inverting plate 44 and the rotation of the conveying screw 26 from the sideways orientation to a downward orientation and is conveyed in the downward orientation by a discharge portion 30 of the conveying screw 26 into a discharge chute 50 and onto a discharge conveyor 24 as shown in FIGS. 8-14. As the set S of objects A and B is conveyed by rotation of the conveying screw 26 and the diverting screw 40, the second object B is engaged by the diverting screw thread 42 and is diverted by rotation of the diverting screw 40 and contact with the diverting screw thread 42 into a reverting pocket 58 (see FIG. 7) formed between a reverting plate 54 and the conveying screw 26, such that the second object B is reverted by a reverting contoured surface 56 of the reverting plate 54 and the rotation of the conveying screw 26 from the sideways orientation to the upward orientation and is conveyed in the upward orientation by the discharge portion 30 of the conveying screw 26 into a discharge chute 50 and onto a discharge conveyor 24 as shown in FIGS. 8-14. The first object A and second object B are alternately discharged by the discharge portion 30 of the conveying screw 26 into the discharge chute 50 and onto the discharge conveyor 24, the first object A being guided toward the central axis 32 of the chute 50 by a first discharge guide 60, and the second object B being guided toward the central axis 32 of the chute 50, such that each set S is discharged sequentially from the chute 50 via a chute exit 52, with the first object A in a downward orientation and the second object B in an upward orientation, in the discharge sequence 72 shown in FIGS. 1, 3 and 7-9. In a non-limiting example, the alternating upward and downward objects 10 are fed out in the discharge sequence 72 from the discharge chute 50 of the drive system 100 via a chute exit 52 to an outfeed conveyor for conveyance, for example, to a subsequent operation such as a packaging operation.

In a non-limiting example, the object 10 has a frustoconical shape as shown in FIGS. 1-3, including a top end surface 12, a tapered side surface 16, and a bottom end surface 14, where in the discharge sequence 72, tapered sides 16 of adjacent alternating upward and downward containers A, B are substantially parallel to each other, as shown in FIG. 3. The tapered side surface 16 can also be referred to herein as a tapered side, a side, or a side surface of the object 10. In the example shown, the top end surface 12 and the bottom end surface 14 are each circular, the top end surface 12 having a top diameter larger than the bottom diameter of the bottom end surface 14 to define an angle of the tapered surface 16 therebetween. In a non-limiting example, the object 10 can be configured as a container, such as a container for packaging foodstuffs. The object 10 can be referred to herein as a container 10. In a non-limiting example, the object 10 may be configured as a container such as a K-cup®, as shown in FIGS. 2 and 3 and FIGS. 11-14, e.g., as a plastic cartridge containing coffee and a filter for use with an electric brewing machine such as a Keurig® coffee maker. The example of a container 10 configured as a K-cup® is non-limiting, such that is would be understood that the object 10 being oriented by the drive system 100 could be a frustoconical container for containing other foodstuffs such as creamer, cereal, ice cream, pudding, yogurt, applesauce, snack foods, etc., and/or a frustoconical container containing other substances or items, etc., which may be oriented by the drive system 100 for subsequent processing and/or packaging.

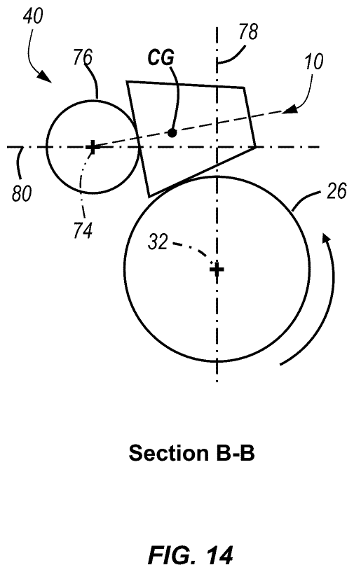

Referring again to FIGS. 1, 1A and 2-7, the alternate inverting drive system 100 includes a conveyor 20, a conveying screw 26, a diverting screw 40, a twisting plate 34, an inverting plate 44, a reverting plate 54, and first and second discharge guides 60, 62 defining a discharge chute 50 and chute exit 52, arranged as shown in the figures. The conveyor 20 includes an infeed conveyor portion 22 and a discharge conveyor portion 24, which can be collectively referred to herein as the conveyor 20. In a non-limiting example, the infeed conveyor portion 22 can be a separate conveyor or can be continuous with and/or a portion of the conveyor 20, and/or the discharge conveyor portion 24 can be a separate conveyor or can be continuous with and/or a portion of the conveyor 20. The infeed conveyor portion 22 can be referred to herein as an infeed conveyor 22. The discharge conveyor portion 24 can be referred to herein as a discharge conveyor 24. A central axis 32 of the drive system 100 is coincident with the axis of the conveying screw 26 and parallel to the axis 74 of the diverting screw 40. The central axis 32 can also be referred to herein as the conveying screw axis, referring to the axis of the conveying screw 26. The axis 74 of the diverting screw 40 can also be referred to herein as the support rail axis 74, referring to the axis of the support rail portion 76 of the diverting screw 40. The alternate inverting drive system 100 includes a drive assembly 18 including at least one motor and linkages for driving the conveying screw 26, and the diverting screw 40 and conveyor 20. The conveying screw 26 and the diverting screw 40 are driven in the direction of rotation 68 shown in FIG. 1A, by the drive system 100. The conveying screw 26 rotates in the direction of rotation 68 to convey the objects 10 in a direction of travel 64 from the infeed portion 22 of the conveyor 20 to the discharge chute 50 and discharge portion 24 of the conveyor 20. The diverting screw 40 rotates in the direction of rotation 68 such that the objects 10 when in the sideways orientation are supported and maintained in the sideways orientation by the support rail portion 76 of the diverting screw 40 while being conveyed in the sideways orientation by the conveying screw 26. In the illustrative example, the top end 12 of the object 10 is in continuous contact with the support rail portion 76 until diverted to the inverting plate 44 or the reverting plate 54. As shown in the figures, the central axis 32 of the conveying screw 26 and the support rail axis 74 of the diverting screw 40 are parallel to each other and non-coincident. As shown in FIG. 14, the diverting screw 40 is parallel to and offset from the conveying screw 26 such that a center of gravity CG of the object 10 when in the sideways orientation is offset to a vertical plane 80 including the diverting screw axis 74, the vertical plane perpendicular to and intersecting a horizontal plane 78 including the central axis 32 of the conveying screw 26. This orientation of the support rail portion 76 of the diverting screw 40 to the conveying screw 26 positively locates and supports the object 10 in the sideways orientation during conveyance of the object 10 along the support rail portion 76 and into the diverting screw thread 42 of the diverting screw 40. The diverting screw 40 rotates in the direction of rotation 68 to maintain the objects 10 in the sideways orientation in contact with the support rail portion 76, and such that the objects 10 are received into the diverting screw thread 42 of the diverting screw 40 in sets S of two objects A, B, where rotation of the diverting screw thread 42 progresses the first object A of the set S to the inverting plate 44 for inversion of the object A to a downward orientation, and where rotation of the diverting screw thread 42 diverts the second object B of the set S to the reverting plate 54 for reversion of the object B to the upward orientation. The alternate inverting drive system 100 can include a controller (not shown) in communication with the drive assembly 18 where the controller is operable to coordinate and/or synchronize actuation, operation and/or movement of the conveying screw 26, and the diverting screw 40 and conveyor 20 of the drive system 100 such that during operation, a continuous and uninterrupted flow of incoming individual upward oriented containers 10 can be received into the infeed portion 28 of the conveying screw 26 and progress in the direction of travel 64 from the infeed conveyor 22 through the twisting plate 34, the diverting screw 40, and alternatively, through the inverting plate 44 or reverting plate 54 to be discharged in an alternate inverted pattern to the discharge chute 50, exiting the discharge chute 50 via the chute exit 52 in the alternate inverted pattern, also referred to herein as the discharge sequence 72 shown in FIG. 3.

The system 100 and method 200 described herein for inverting alternate containers in a sequence is characterized by numerous advantages as compared with pick and place methods and systems for alternating the orientation of containers in a sequence. For example, by maintaining a continuous supportive contact, that is, positive engagement, of the container 10 throughout the infeed, twisting, reverting and/or inverting, and alternating processes, instability of the container during movement is minimized and/or substantially eliminated. Further, the alternating upward and downward containers 10 exhibit greater stability for transfer via conveyor, for example, relative to a sequence 70 of containers 10 which are all in an upward orientation, where point to point contact at the top edges of the adjacent containers has a greater potential for tipping relative to alternating upward and downward containers 10 having tapered sides 16 of adjacent containers 10 which are substantially parallel to each other. By comparison, alternating upward and downward containers 10 are readily transported via conveyors, chutes, etc. to subsequent operations such as sleeving, bulk packing, etc., where the alternate inverted pattern of the alternating upward and downward containers 10 increase the pack density of the containers 10 as compared to containers 10 which are all oriented in a single upward or single downward direction. The example shown in FIGS. 2 and 3 illustrate the improvement in the pack density of the containers 10 when oriented in the alternative inverted pattern. In the example shown in FIG. 2, an infeed sequence 70 of four objects 10 have a pack length L2 which is the sum of the top diameters of the top surfaces 12 of the four objects 10 in the infeed sequence 70. In the example shown in FIG. 3, a discharge sequence 72 of four objects 10 have a pack length L3 which is the sum of the top diameter of the top surface 12 of two of the objects 10 and the bottom diameter of the bottom surface 14 of two of the objects 10 in the discharge sequence 72, where the pack length L3 of the discharge sequence 72 is less than the pack length L2 of the infeed sequence 70.

The continuous flow aspect of the system 100 and method 200 disclosed herein, where contact with the containers 10 by the conveying screw 26 through infeed, translation of the containers 10 by the conveying screw 26 in conjunction with the twisting plate 34 from upward to sideways orientation, conveying the containers 10 in sets S of two containers A, B (see FIGS. 8-13) to a diverting screw 40 such that the first container 10 of each set S is inverted by the diverting screw 40 and an inverting plate 44 to a downward orientation and the second container 10 of each set S is reverted by the diverting screw 40 and a reverting plate 54 to be conveyed by a discharge end 30 of the conveying screw 26 to a discharge chute 50 in as a set S including the first container A in an downward orientation and the second container B in an upward orientation, combining the first and second containers A,B in alternating orientation to adjacent containers 10 for discharge in a single lane, enables high speed movement of the containers through the twisting, diverting, inverting, reverting and discharge segments, such that relatively high throughputs in the range of up to 1450 containers per minute (cpm) have been realized. Further, because of the continuous flow aspect of the process, the throughput rate can be varied by modifying the rotation speed of the conveying and diverting screws, such that the throughput of the line can be continuously varied in a range of 0 cpm to about 1450 cpm.

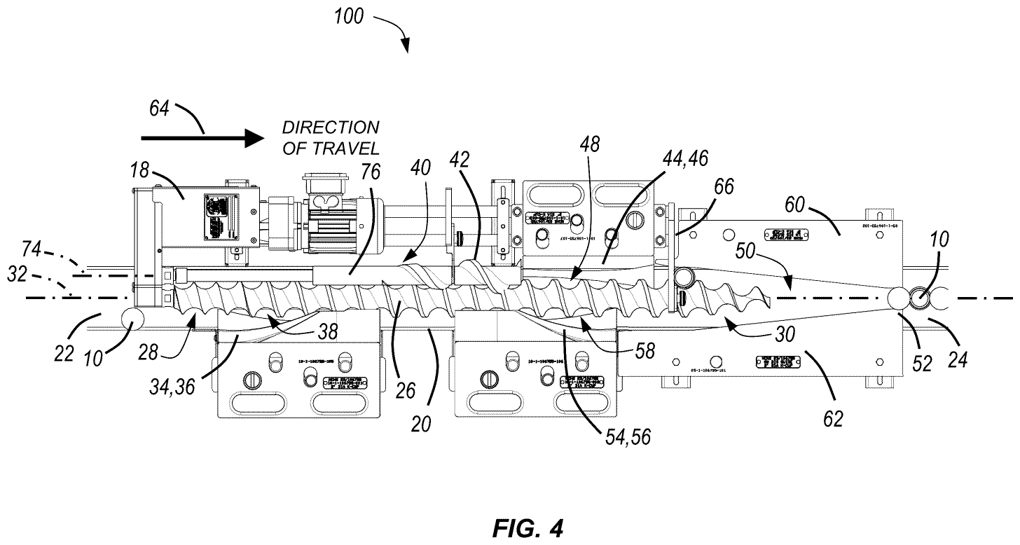

FIGS. 4-7 show the arrangement of the conveying screw 26, twisting plate 34, diverting screw 40, inverting plate 44 and reverting plate 54 relative to each other, for progressing the sequence of containers 10 through the alternate inverting drive system 100. As shown in exploded view in FIG. 7, each of the twisting plate 34, inverting plate 44 and reverting plate 54 define a respective contoured surface 36, 46, 56. The twisting contoured surface 36 and the conveying screw 26 define one or more twisting pockets 38 therebetween, for receiving each container 10 from the infeed sequence 70 in an upward orientation and twisting the container 10, through rotation of the container 10 by the conveying screw 26 along the twisting contoured surface 36 of the twisting plate 34, from the upward orientation to a sideways orientation, as shown in the figures. The inverting contoured surface 46 and the conveying screw 26 define one or more inverting pockets 48 therebetween, for receiving alternating containers 10, e.g., the first container A [A1, A2, . . . A14] of each respective set of containers S [S1, S2, . . . S14] conveyed through the diverting screw 40 as shown in FIGS. 8 and 9, in the sideways orientation and inverting the container A, through rotation of the container 10 by the conveying screw 26 along the inverting contoured surface 46 of the inverting plate 44, from the sideways orientation to an inverted orientation, as shown in the figures. The reverting contoured surface 56 and the conveying screw 26 define one or more reverting pockets 58 therebetween, for receiving alternating containers 10, e.g., the second container B [B1, B2, . . . B14] of each respective set of containers S [S1, S2, . . . S14] conveyed through the diverting screw 40 as shown in FIGS. 8 and 9, in the sideways orientation and reverting the container B, through diversion of the second container B by contact of the diverting screw thread 42 with the container B reverting the second contained B from the sideways orientation into a reverting pocket 58 in the upward orientation, such that the reverted container B is conveyed by the conveying screw 26 along the reverting contoured surface 56 of the reverting plate 54, in the upward orientation, as shown in the figures.

Referring to FIGS. 8-10, the inverted containers A of each container set S are conveyed in the downward orientation by the discharge portion 30 of the conveying screw 26 on the discharge conveyor 24 along one side of the conveying screw 26 (relative to the central axis 32) between the conveying screw 26 and a first discharge guide 60. The reverted containers B of each container set S are conveyed in the upward orientation by the discharge portion 30 of the conveying screw 26 on the discharge conveyor 24 along the opposite side of the conveying screw 26 (relative to the central axis 32) between the conveying screw 26 and a second discharge guide 62, such that as the containers 10 are discharged from the conveying screw 26 into the discharge chute 50, the containers 10 are in an alternate inverted pattern, with each downward oriented container A adjacent an upward oriented container B, as shown in the figures and in the discharge sequence illustrated by FIG. 3. Referring to FIG. 9, in an illustrative example, upward container B1 is adjacent to downward containers A1 and A2, downward container A2 is adjacent to upward containers B1 and B2, and so on. The containers 10 exit the discharge chute 50 on the discharge conveyor 24 in the alternate inverted pattern, also referred to herein as the discharge sequence 72. In a non-limiting example, the drive system 100 can include a guide plate 66 located over the discharge portion 30 of the conveying screw 26, to stabilize the containers 10 on the discharge conveyor 24 as the containers 10 exit the inverting plate 44 and the reverting plate 54.

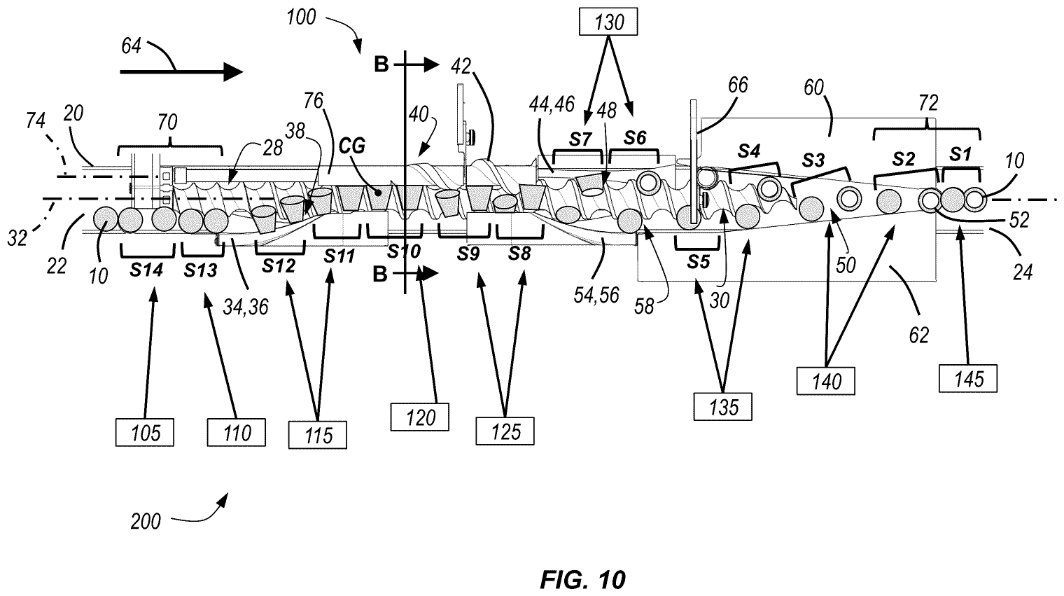

FIGS. 8-13 illustrate an alternate inverting method 200 for alternate inverting of objects 10, the steps of the method 200, referring to FIG. 10, including:

At step 105 of the alternate inverting method 200, as illustrated by object set S14, containers 10 are progressed via an infeed conveyor 22 in an upward orientation in the infeed sequence 70 shown in FIG. 2, in the direction of travel 64, to an infeed portion 28 of the conveying screw 26.

At step 110 of the alternate inverting method 200, as illustrated by object set S13, the infeed sequence 70 of containers 10 is progressed axially by the conveying screw 26 such that each of the upward oriented containers 10 is engaged by a twisting pocket 38 defined by the conveying screw 26 and the twisting contoured surface 36 of the twisting plate 34.

At step 115 of the alternate inverting method 200, as illustrated by object sets S11, S12, the upward oriented container is twisted by rotation of the conveying screw 26 and engagement with the twisting contoured surface 36 from the upward orientation to a sideways orientation.

At step 120 of the alternate inverting method 200, as illustrated by object set S10, the container 10 is conveyed by the conveying screw 26 in the direction of travel 64, retained between the twisting plate 34 and the diverting screw 40 in the sideways orientation.

At step 125 of the alternate inverting method 200, as illustrated by object sets S8, S9, the containers 10 are received in sequential sets S1, S2, S3 into the diverting screw thread 42 of the diverting screw 40, each set Sn consisting of two adjacent containers, a first container A and a second container B and progressed axially by the conveying screw 26, where the diverting screw thread 42 is configured such that the first container A of the set S is not engaged by the diverting screw thread 42 and is discharged from the diverting screw 40 into an inverting pocket 48 formed between the inverting plate 44 and the conveying screw 26, and where the diverting screw thread 42 is configured such that the second container B of the set S is contacted by the diverting screw thread 42 and is diverted by rotation of the diverting screw 40 into a reverting pocket 58 formed between a reverting plate 54 and the conveying screw 26.

At step 130 of the alternate inverting method 200, as illustrated by object sets S6, S7, as previously described herein and illustrated by FIGS. 8-13, the first containers A of each of the sets S are inverted in the inverting pocket 48 into a downward orientation as the container A is progressed axially in the direction of travel 64 by the conveying screw 26, and the second containers B of each of the sets S are reverted in the reverting pocket 58 into the upward orientation as the container B is progressed axially in the direction of travel 64 by the conveying screw 26, where the inverting pockets 48 and reverting pockets 58 are alternated axially along the conveying screw 26.

At step 135 of the alternate inverting method 200, as illustrated by object sets S4, S5, the downward oriented containers A in the inverting pockets 48 and the upward oriented containers B in the reverting pockets 58 are progressed in an alternate inverted pattern by the discharge portion 30 of the conveying screw 26, the downward orientated containers A being retained in the inverting pockets 48 between a first discharge guide 60 and a first side of the conveying screw 26, and the upward orientated containers B being retained in the reverting pockets 58 between a second discharge guide 62 and a second side of the conveying screw 26, such that, at step 140, as illustrated by object sets S2, S3, the containers 10 are discharged from the conveying screw 26 into the discharge chute 50 in the alternate inverted pattern shown in FIG. 3, with each downward oriented container A sequenced adjacent an upward oriented container B, in the discharge sequence 72.

At step 145 of the alternate inverting method 200, as illustrated by object set S1, the alternating upward and downward objects 10 are fed out from discharge chute 50 of the drive system 100 via the chute exit 52 to an outfeed conveyor for conveyance, for example, to a subsequent operation such as a packaging operation.

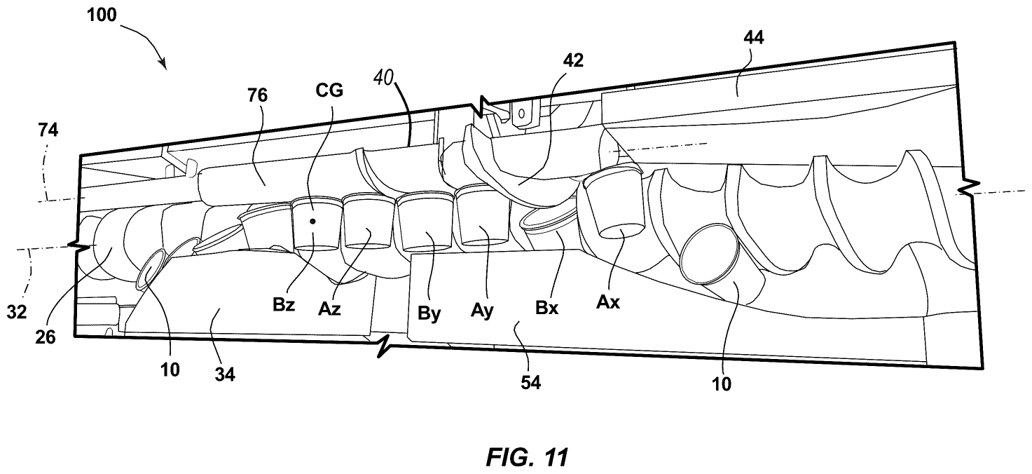

FIGS. 11-13 show another example of the alternate inverting method 200, illustrating the conveyance and movement of sequential first object set Ax, Bx, second object set Ay, By, and third object set Az, Bz through steps 125-130 of the method 200.

The examples shown in FIGS. 1-14 of the alternate inverting drive system 100 and method 200 are not intended to be limiting. For example, the configuration of the discharge guides 60, 62 can be modified to straight guides, such that at step 140 of the alternate inverting method 200, the downward oriented objects A are discharged to a first side of the discharge conveyor 24, and the upward oriented objects B are discharged to a second side of the discharge conveyor 24. In this example, the discharge conveyor 24 can consist of first and second discharge conveyors (not shown), the first discharge conveyor being positioned adjacent the first discharge guide 60 to receive the downward oriented objects A, and the second discharge conveyor being positioned adjacent the second discharge guide 62 to receive the upward oriented objects B, such that all the downward oriented objects A exit the drive system 100 via the first discharge conveyor, and such that all the upward oriented objects B exit the drive system 100 via the second discharge conveyor. In this example, a separating guide rail (not shown) can be positioned at the discharge end 30 of the conveying screw 26, between the first and second discharge conveyors, to provide additional separation between the downward oriented objects A exiting from one side of the conveying screw 26, and the upward oriented objects B exiting from the other side of the conveying screw 26.

As used herein, the terms “a,” “an,” “the,” “at least one,” and “one or more” are interchangeable and indicate that at least one of an item is present. A plurality of such items may be present unless the context clearly indicates otherwise. All numerical values of parameters, quantities, or conditions in this disclosure, including the appended claims, are to be understood as being modified in all instances by the term “about” or “approximately” whether or not “about” or “approximately” actually appears before the numerical value. “About” and “approximately” indicate that the stated numerical value allows some slight imprecision (e.g., with some approach to exactness in the value; reasonably close to the value; nearly; essentially). If the imprecision provided by “about” or “approximately” is not otherwise understood with this meaning, then “about” and “approximately” as used herein indicate at least variations that may arise from methods of measuring and using such parameters. Further, the terminology “substantially” also refers to a slight imprecision of a condition (e.g., with some approach to exactness of the condition; approximately or reasonably close to the condition; nearly; essentially). In addition, disclosed numerical ranges include disclosure of all values and further divided ranges within the entire disclosed range. Each value within a range and the endpoints of a range are all disclosed as separate embodiments. The terms “comprising,” “includes,” “including,” “has,” and “having” are inclusive and therefore specify the presence of stated items, but do not preclude the presence of other items. As used in this disclosure, the term “or” includes any and all combinations of one or more of the listed items.

The above features and other features and advantages of the present invention are readily apparent from the detailed description of the best modes for carrying out the invention described herein, when taken in connection with the accompanying drawings. While some of the best modes and other embodiments for carrying out the claimed invention have been described in detail, various alternative designs and embodiments exist for practicing the invention.

1. An alternate inverting drive system, comprising:
a conveyor including an infeed conveyor portion and a discharge conveyor portion;
a conveying screw including an infeed portion and a discharge portion;
a diverting screw including a support rail portion and a diverting screw thread;
an inverting plate;
a reverting plate;
the conveying screw, the diverting screw, the inverting plate, and the reverting plate being configured to:
receive objects to the infeed portion of the conveying screw and the support rail portion of the diverting screw, the objects in a sideways orientation relative to the infeed conveyor portion;
convey the objects in the sideways orientation along the conveying screw, from the support rail portion to the diverting screw thread of the diverting screw;
convey the objects via the diverting screw thread in sets along the conveying screw, each set including a first object and a second object;
divert, via the diverting screw, the first object of each set to the inverting plate adjacent the conveying screw;
invert the first object of each set between the inverting plate and the conveying screw to a downward orientation relative to the infeed conveyor portion;
divert, via the diverting screw, the second object of each set to the reverting plate adjacent the conveying screw;
revert the second object between the reverting plate and the conveying screw to an upward orientation relative to the infeed conveyor portion; and
discharge to the discharge conveyor portion of the conveyor, via the discharge portion of the conveying screw, the first and second objects in a discharge sequence in which each object in the downward orientation is alternated with an object in the upward orientation.

2. The alternate inverting drive system of claim 1, wherein the conveying screw is positioned between the inverting plate and the reverting plate.

3. The alternate inverting drive system of claim 1, further comprising:
an inverting contoured surface defined by the inverting plate;
an inverting pocket defined by the inverting contoured surface and the conveying screw; and
the inverting pocket configured to receive the first object from the diverting screw.

4. The alternate inverting drive system of claim 1, further comprising:
a reverting contoured surface defined by the reverting plate;
a reverting pocket defined by the reverting contoured surface and the conveying screw; and
the reverting pocket configured to receive the second object from the diverting screw.

5. The alternate inverting drive system of claim 1, wherein the diverting screw is positioned relative to the conveying screw such that the object in the sideways orientation is in continuous contact with the support rail portion of the diverting screw.

6. The alternative inverting drive system of claim 5, wherein:
the object has a frustoconical shape including a top end surface and a bottom end surface;
the top end surface having a top diameter larger than a bottom diameter of the bottom end surface; and
wherein, in the sideways orientation, the top end surface is in continuous contact with the support rail portion of the diverting screw.

7. The alternative inverting drive system of claim 1, further comprising:
the object having a center of gravity;
a diverting screw axis defined by the diverting screw;
a first plane including the diverting screw axis;
a conveying screw axis defined by the conveying screw;
a second plane including the conveying screw axis; and
wherein the first and second planes are intersecting and perpendicular to each other such that the center of gravity is offset to the first plane with the object in the sideways orientation.

8. The alternate inverting drive system of claim 1, further comprising:
a twisting plate adjacent the infeed portion of the conveying screw;
the conveyor, the conveying screw, and the twisting plate being configured to:
convey, via the infeed conveyor portion, the objects in an initial upward orientation to the infeed portion of the conveying screw;
receive the objects between the infeed conveyor portion and the twisting plate; and
twist the objects from the initial upward orientation to the sideways orientation by conveying the objects between the twisting plate and the conveying screw.

9. The alternative inverting drive system of claim 8, further comprising:
a twisting contoured surface defined by the twisting plate;
a twisting pocket defined by the twisting contoured surface and the conveying screw; and
the twisting pocket configured to receive the object from the infeed conveyor portion.

10. The alternative inverting drive system of claim 8, wherein:
the object has a frustoconical shape including a top end surface and a bottom end surface;
the top end surface having a top diameter larger than a bottom diameter of the bottom end surface; and
wherein, in the initial upward orientation, the bottom end surface is in contact with the infeed conveyor portion.

11. The alternative inverting drive system of claim 1, wherein:
the object has a frustoconical shape defining a tapered side; and
in the discharge sequence, a tapered side of the first object in the downward orientation is parallel to a tapered side of the second object in the upward orientation.

12. A method for alternate inverting of objects, the method comprising:
receiving objects via an infeed conveyor portion of a conveyor to an infeed portion of a conveying screw and a support rail portion of a diverting screw, the objects in a sideways orientation relative to the infeed conveyor portion;
conveying the objects in the sideways orientation along the conveying screw, from the support rail portion to a diverting screw thread of the diverting screw;
conveying the objects via the diverting screw thread in sets along the conveying screw, each set including a first object and a second object;
diverting, via the diverting screw, the first object of each set to an inverting plate adjacent the conveying screw;
inverting the first object of each set between the inverting plate and the conveying screw to a downward orientation relative to the infeed conveyor portion;
diverting, via the diverting screw, the second object of each set to a reverting plate adjacent the conveying screw;
reverting the second object of each set between the reverting plate and the conveying screw to an upward orientation relative to the infeed conveyor portion; and
discharging to a discharge conveyor portion, via a discharge portion of the conveying screw, the first and second objects in a discharge sequence in which each object in the downward orientation is alternated with an object in the upward orientation.

13. The method of claim 12, wherein the conveying screw is positioned between the inverting plate and the reverting plate.

14. The method of claim 12, further comprising:
an inverting contoured surface defined by the inverting plate;
an inverting pocket defined by the inverting contoured surface and the conveying screw;
the method further comprising:
receiving the first object from the diverting screw to the inverting pocket.

15. The method of claim 12, further comprising:
a reverting contoured surface defined by the reverting plate;
a reverting pocket defined by the reverting contoured surface and the conveying screw;
the method further comprising:
receiving the second object from the diverting screw to the reverting pocket.

16. The method of claim 12, further comprising:
maintaining the object in continuous contact with the support rail portion of the diverting screw when the object is in the sideways orientation.

17. The method of claim 12, further comprising:
the object having a center of gravity;
a diverting screw axis defined by the diverting screw;
a first plane including the diverting screw axis;
a conveying screw axis defined by the conveying screw;
a second plane including the conveying screw axis; and
wherein the first and second planes are intersecting and perpendicular to each other such that the center of gravity is offset from the first plane with the object in the sideways orientation.

18. The method of claim 12, further comprising:
receiving the objects between the infeed conveyor portion and a twisting plate;
wherein the twisting plate is adjacent the infeed portion of the conveying screw;
the method further comprising:
conveying, via the infeed conveyor portion, the objects in an initial upward orientation to the infeed portion of the conveying screw; and
twisting the objects from the initial upward orientation to the sideways orientation by conveying the objects between the twisting plate and the conveying screw.

19. The method of claim 18, further comprising:
a twisting contoured surface defined by the twisting plate;
a twisting pocket defined by the twisting contoured surface and the conveying screw; and
the twisting pocket configured to receive the object from the infeed conveyor portion.

20. The method of claim 12, wherein:
the object has a frustoconical shape defining a tapered side; and
in the discharge sequence, a tapered side of the first object in the downward orientation is parallel to a tapered side of the second object in the upward orientation.
